(19) United States
(12) Patent Application Publication
(10) Pub. No.: US 2006/0156346 A1
(43) Pub. Date: Jul. 13, 2006

(54) Method of ordering goods and services

(76) Inventor: Henryk Kulakowski, Stalowa Wola (PL)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/552,628

(22) PCT Filed: Feb. 29, 2004
(86) PCT No.: PCT/PL04/00014

§ 371 Date: Feb. 1, 2006

(30) Foreign Application Priority Data
Apr. 9, 2003 (PL) P.359608

(51) Int. Cl. H04N 5/445; G07F 7/00; G06F 3/00; G06F 17/30; G06Q 30/00

(52) U.S. Cl. 725/60; 705/26; 705/27

(57) ABSTRACT

According to the invention, the method of ordering goods and services, related to the transmission received by the customer, is distinguished by the fact that during the reception of the transmission the customer initiates the connection to the system of ordering goods and services, unequivocally related to the received transmission and during the connection the customer orders goods or services offered by the system of ordering goods and services, which refer to the transmission. Preferably, the system of ordering goods and services is available for the whole duration of the transmission, being always available in the same manner, dynamically changing the offer of goods and services depending on the transmission, and in case of lack of the offer suitably informing the customer during the connection or optionally not servicing this connection at all.

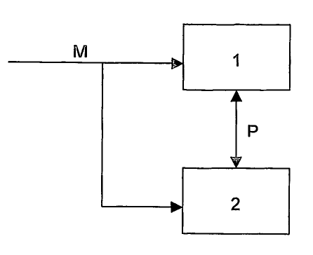

### FIELD OF THE INVENTION

This invention relates to a method of ordering goods and services.

### BACKGROUND OF THE INVENTION

Several methods are known for remote ordering goods and services. The method described in US 2003/0204847A1 gives opportunity of ordering during a TV broadcast. A customer watching TV receives a transmission with an additional offer, basing on which he makes an order by means of a remote control unit. The TV broadcaster sends the customer an encoded offer, together with the TV signal, and taking advantage of the offer requires possession of a dedicated device.

The document WO0031906 describes a method of transmission of additional data during a digital radio broadcast, whereby a customer receiving the transmission may order the received contents. Also this solution requires the utilization of special devices on both the sender and the receiver sides and the modification of the broadcast radio signal.

The system and the method of WO0223773 enables ordering of media contents due to transmission of additional RDS system data concerning the availability of presented contents in the world wide web and the designation of the transmitted composition with the reference number enabling its unequivocal identification. Also in this case a special device is recommended for making an order and the radio signal comprises additional data concerning the availability of the composition.

The method and devices described in US2003104804 allow for ordering goods and services without the necessity of encoding any additional data concerning the offer in the radio signal. However, this solution requires localization of the user and identification of the frequency of the radio signal received by the user. This solution requires a special device and also limits the area of application.

The method and the system described in WO03003143 allow for ordering goods and services by use of commonly available data communication devices, wherein the order has to be specified and the system servicing the order generates an answer to the customer's query basing on stored customer data and his preferences.

U.S. Pat. No. 5,703,795 describes a method of providing data to a customer in connection with the broadcast received by the customer. The information to be sent to the customer is generated basing on the identification of the broadcasting station and the broadcast time, which allows for unequivocal determination of the contents that were broadcast at the moment of reception of the customer's query and for generation of additional data. The above-described method only relates to generation of additional data and is utilized only in connection with radio-television services. In the mentioned document a number of embodiments and solutions are described for identification of the broadcast program and the broadcast time and sending the data to the system that generates additional data. However, the only effect of the proposed solutions is still only the additional data received by the customer.

Practical utilization of the state of the art solutions is frequently hindered by the fact that a given radio or TV station may by broadcast on different frequencies, depending on location, and very often these frequencies may be exchanged between different stations. It makes more difficult to identify the station unequivocally basing on the utilized frequency. Several other methods of identification are known, one of them being for example the assignment of the station ID to a button of a memory card, as proposed in U.S. Pat. No. 5,949,492. Still, however, two parameters are needed in the above-mentioned solutions: the identification of the sender and the time of the broadcast, and moreover the field of the application is limited to the radio-television signals.

In US2002028665 a method and a device is described for delivering additional data connected with the broadcast program in response to a telephone query. The assumption for the described method is that the broadcast contents, basing on which the additional data are generated, are identified basing on the telephone call initiated by the customer. Still, however, the generation of additional data depends on the identification of the sender and the broadcasting time and the described method is only used for transmission of additional data.

The state of the art comprises a great variety of methods of remote ordering goods and services or delivering additional data. In most cases, the customer receives a radio or television transmission in which additional data are encoded concerning the available offer. Such solutions typically require application of special receiving devices and the transmitted signal has to be suitably modified. Another group are the solutions in which the transmitted contents are identified basing on the identification of the sender and the broadcast time, the additional data being generated basing on the contents.

The state of the art solutions are based on the radio-television transmission, which is the necessary element of the described inventions. On the contrary, the solution according to the invention gives broader opportunities for ordering goods and services and is more universal and intuitional. The transmission received by the customer does not need to be a radio/television signal. According to the invention, the transmission may be a given state of the customer, a set of sensations or feelings coming from the surrounding reality. The received transmission may be for example an external advertisement, Internet service, a movie in the cinema or music listened by the customer. The transmission may also be any reality surrounding the customer and a condition the customer is in, e.g., illness, tiredness, and joy. It is important to identify this transmission unequivocally.

The objective of the invention is to make available to a customer the service by means of which he could freely order goods or services under the influence of the surroundings, especially under influence of an impulse the surroundings has exerted on the customer. The condition of offering the customer goods or services is the feasibility of identification of stimuli and sensations affecting the customer at a given moment.

### SUMMARY OF THE INVENTION

According to the invention, the method of ordering goods and services, related to the transmission received by the customer, is distinguished by the fact that during the reception of the transmission the customer initiates the connection to the system of ordering goods and services, unequivocally related to the received transmission and during the connection the customer orders goods or services offered by the system of ordering goods and services, which refer to the transmission. Preferably, the system of ordering goods and services is available for the whole duration of the transmission, being always available in the same manner, dynamically changing the offer of goods and services depending on the transmission, and in case of lack of the offer suitably informing the customer during the connection or optionally not servicing this connection at all.

The method according to the invention is also characterized in that at any moment of the transmission, optionally instead of initiating the connection, the customer remembers the current time of the transmission and sends it later during a suitable connection to the system of ordering goods and services, basing on that time the range of the formerly broadcast transmission being identified, and the offer of goods and services being made available to the customer, identical to that he would have had access to at the remembered time.

Preferably, the order parameters are given during the connection and part of the order parameters, concerning the customer, are available in the system of ordering goods and services and taken during the connection basing on the identification of the customer.

Preferably, instead of the connection the exchange of messages between the customer and the system of ordering goods and services is proceeded.

The method according to the invention wherein the connection, during which the customer is unequivocally identified, is only a confirmation of interest of the customer in the offer of the system of ordering goods and services related to the transmission, and basing on this confirmation and, preferably, other such confirmations the customer considers offers generated by the system basing on the identification of the customer and connections received from him, during a later contact with the system of ordering goods and services.

Preferably, the transmission is a multimedia transmission in terms of text, images, sound and all possible combinations thereof in any media. The transmission is also a set of sensations or feelings of any type the customer has or conditions he is in during the connection.

### BRIEF DESCRIPTION OF THE DRAWINGS

The invention is presented by means of examples and with reference to the accompanying drawing, which shows general method of ordering goods and services.

### DETAILED DESCRIPTION OF THE PREFERRED EMBODIMENTS

According to the invention illustrated in the drawing, the customer 1 receiving the transmission M is interested in buying goods or services related to the transmission M, under the influence of stimuli affecting him during the transmission. The customer 1 has knowledge on how to make the connection P to the system 2 of ordering goods and services and is sure that the system 2 is active during the whole transmission M and is always available in the same manner. The system 2 of ordering goods and services unequivocally identifies the contents of the transmission M under the influence of which the connection P has been established. The identification is made by the system 2 of ordering goods and services basing on knowledge of the reason for making the connection P by the customer 1. During the connection P the customer 1 orders goods or services. The customer 1 receives an offer from the system 2 of ordering goods and services, the offer being related to the transmission M, basing on which he specifies his order.

Optionally, the order concerns one piece of goods or one service only, which needs not to be chosen from the offer.

Optionally, the connection P is only a declaration of the customer 1, unequivocally identified during the connection P, to be interested in buying the goods or services. The process of ordering together with the specification of necessary order parameters is proceeded later during contact between the customer 1 and the system 2 of ordering goods and services, preferably all such declarations of the customer 1 submitted so far being serviced that time.

The parameters necessary to make the order or payment for the order are specified fully during the connection P or are partially taken from the system 2 of ordering goods and services basing on the identification of the customer 1, given that the data are known.

Optionally, the connection P is a set or a sequence of messages exchanged between the customer 1 and the system 2 of ordering goods and services, which allow the customer 1 to make the order.

In the case the customer 1 cannot establish the connection P at any moment he wants to make an order, he remembers the current time he wanted to make the order, afterwards, at any suitable moment, he establishes the connection P during which he sends the remembered time to the system 2 of ordering goods and services, this causing the generation of the service identical to that which would be available at the remembered time.

### EXAMPLE 1

The customer 1 is listening to the radio station co-operating with the Internet service playing the role of the system 2 of ordering goods and services, which accurately monitors the broadcast cycle of programs defining the transmission M. The Internet service is available at a known Internet address and WAP site. The offer on the Internet pages changes dynamically depending on the current contents broadcast in the transmission M. Listening to a song, the customer 1 decides to buy it. He establishes the connection P (from a computer or a mobile phone) to the system 2 of ordering goods and services—here the Internet service, and receives an offer to purchase the just being broadcast composition in digital form, a CD single, the whole album to which the composition belongs and the band poster.

The customer 1 orders chosen items.

### EXAMPLE 2

The customer 1 listens to the radio station, the station being simultaneously the system 2 of ordering goods and services available at a phone number with additional charge, the number being known to the listeners. During the whole broadcast, being the transmission M, the customer 1 may buy goods or services at the phone number. By calling the number and making the connection P during a song, the customer 1 may: buy the song, dedicate it to another person or take part in a quiz concerning the performer of the song. By making the connection P to the same number, for example during an interview, the customer 1 may order the interview in digital form, may order additional materials, basing on which the program was performed, or ask a question to the participants of the interview. The service is charged due to the additional charge for the phone connection.

### EXAMPLE 3

The customer 1 watching a TV program, being the transmission M, may order goods and services relating to the received transmission M. The service is available at the telephone number of the TV station which at the same time is the system 2 of ordering goods and services to which the customer 1 makes the connection P by sending the SMS message “order”. In response the customer 1 receives the information about the offer of goods and services related to the TV program being currently broadcast. The customer 1 may order the broadcast program in the form of a computer file, DVD or videotape. Because the use of the service requires former registration on the Internet page of the system 2 of ordering goods and services, where the customer 1 introduces his data, therefore the customer 1 only confirms the purchase of the chosen items during the connection P and the ordering process whereas the remaining transaction parameters are filled in automatically basing on the identification of the mobile telephone number of the customer 1.

In the case the customer 1 has sent an SMS message during the advertisement of a given product, the system 2 of ordering goods and services allows for ordering the advertised product, ordering additional information or requesting a telephone contact with the advertiser's representative.

### EXAMPLE 4

When driving a car, the customer 1 is listening to the radio station broadcasting only music compositions, being the transmission M. The customer 1 may order any composition by making a connection P to a special telephone number. After making the connection P to the system 2 of ordering goods and services, the customer 1 (or the system automatically) disconnects. The connection P to the system 2 of ordering goods and services amounts to the declaration to purchase the composition. The service requires his telephone number not to be unlisted. At any moment the customer 1 calls the system 2 of ordering goods and services again (at the same number or another), confirms the order of the chosen compositions and gives his address data.

### EXAMPLE 5

The customer 1 utilizes a telephone when dancing at the disco. The customer 1 may buy any of the presented compositions, being the transmission M, getting it recorded on CD-R disc when leaving the disco. In order to order the composition on such a disc, the customer 1 must make the connection P to a given telephone number of the system 2 of ordering goods and services during the presentation of the composition and then disconnect. It is required that the telephone number of the customer 1 is not unlisted. In order to receive the disc, the customer 1 gives his telephone number from which the connections P were made and balances an account.

### EXAMPLE 6

Advertisement films are presented on the screens placed on the buildings, the films defining the transmission M. One clearly seen telephone number of the system 2 of ordering goods and services is also presented, the connection P being possible thereto for making an order concerning the currently presented advertisement. The offer of goods and services changes dynamically depending on the contents being displayed at a given moment. An interested customer 1, being for example a driver stuck in a traffic jam, makes the connection P always to the same number, whereby he does not need to note the numbers presented in the advertisement.

### EXAMPLE 7

The radio broadcasting station makes music players available to the listeners, the players being equipped with radio receiver, watch, and memory and being able to play digital music. When listening to the station broadcasting the transmission M, the customer 1 presses the button “Order” placed on the player, which causes storing the current date and time in the memory of the player. After connecting the player to the computer, the special software makes connection P to the Internet site of the system 2 of ordering goods and services, i.e., the broadcasting station in this case, and transmits the time data stored in the player, which causes generation of an offer of music compositions for the customer 1, the compositions were played that time and being available to order now. The system 2 of ordering goods and services may be the broadcasting station in this case.

### EXAMPLE 8

The customer 1 has at his disposal a cellular telephone with a radio receiver built in with the function RDS. At any moment, the customer 1 is able to connect to the system 2 of ordering goods and services by means of the software integrated with the telephone, thereafter the software automatically transmits the name of the radio station, known thanks to the RDS function, basing on which the system 2 of ordering goods and services selects the offer from which the customer 1 may order goods or services.

### EXAMPLE 9

Time-synchronized advertisements are displayed on special monitors in cars of underground railways, the advertisements being the transmission M. The advertisements are displayed at the same time on all the monitors and in all of the cars. One telephone number of the system 2 of ordering goods and services is available during the whole broadcast, a customer 1 calling the number if interested in any of the advertisements. The system 2 of ordering goods and services accepts the connection P, confirms the declaration of interest of the customer 1 in the advertisement and automatically disconnects. The user 1 entering the Internet site of the system 2 of ordering goods and services at any time identifies himself by means of his telephone number and a disposable password he had received to his telephone number. The full offer of goods and services is available on the Internet page, the offer being related to the entries from the customer 1 and to the advertisements broadcast that time.

### EXAMPLE 10

A travel agency displays short films related to the offered travels, day and night in the shop window, the films defining the transmission M. Also a telephone number is visible to be called to make an order in the system 2 of ordering goods and services. The customer 1 watching a film has possibility to make the connection P to the number where he receives an offer related to the film presented that time.

### APPLICATIONS IN INDUSTRY

The solution according to the invention gives the customer the feasibility to order goods and services freely under the influence of stimuli affecting the customer, this being advantageous both for the seller as well as for the customer. Action under the influence of stimuli is more spontaneous and the decisions are made more quickly, which more often brings positive results. The customer receives an offer of the goods or services adjusted to a given situation he experiences at the moment. The seller has the feasibility to present a consistent offer of goods and services to the customer according to various criteria. The whole ordering process is very interactive and simple thanks to the dynamical adjustment of the offer to the given situation. No specialized devices are required either. The additional advantage is that the proposed solution allows for introduction of new, unusual transmission forms or promotion of goods and services.

1-8. (canceled)

9. A method of ordering goods and services, related to a transmission received by a customer, is characterized in that during reception of the transmission the customer initiates a connection to a system for ordering goods and services, related to the received transmission and during the connection the customer orders goods or services offered by the system for ordering goods and services, which refer to the transmission, the system for ordering goods and services being available for the duration of the transmission, dynamically changing the offer of goods and services depending on the transmission, and in the case of an inability to offer certain goods and services, either suitably informing the customer of the inability during the connection or not servicing the connection.

10. A method according to claim 1 characterized in that at any moment of the transmission, instead of initiating the connection, the customer remembers the current time of the transmission and sends it later during a suitable connection to the system of ordering goods and services, based on that time the range of the formerly broadcast transmission being identified, and the offer of goods and services being made available to the customer, identical to what the customer would have had access to at the remembered time.

11. A method according to claim 1 characterized in that the order parameters are given during the connection.

12. A method according to claim 1 characterized in that part of the order parameters, concerning the customer are available in the system of ordering goods and services and taken during the connection basing on the identification of the customer.

13. A method according to claim 1 characterized in that instead of the connection the exchange of messages between the customer and the system of ordering goods and services is enabled.

14. A method according to claim 1 characterized in that the connection during which the customer is identified, is a confirmation of interest of the customer in the offer of the system of ordering goods and services related to the transmission and basing on this confirmation and, other such confirmations the customer considers offers generated by the system based on the identification of the customer and connections received from the customer during a later contact with the system of ordering goods and services.

15. A method according to claim 1 characterized in that the transmission is a multimedia transmission.
